(19) United States
(12) Patent Application Publication
(10) Pub. No.: US 2017/0173544 A1
(43) Pub. Date: Jun. 22, 2017

(54) APPARATUS FOR MIXING NUT BUTTER AND THE LIKE

(71) Applicant: Keith Phillip Laby, Oakland, CA (US)

(72) Inventor: Keith Phillip Laby, Oakland, CA (US)

(21) Appl. No.: 15/382,195

(22) Filed: Dec. 16, 2016

Related U.S. Application Data
(60) Provisional application No. 62/269,813, filed on Dec. 18, 2015.

(51) Int. Cl. B01F 7/16; B01F 3/10; B01F 15/00; B01F 7/18

(52) U.S. Cl. CPC B01F 7/161; B01F 7/18; B01F 3/10; B01F 15/00798; B01F 15/00909; B01F 15/00506; B01F 2003/105; B01F 2215/0014; A23L 25/30

(57) ABSTRACT

A mixing apparatus operable by a consumer user for mixing nut butter and the like while in its original container. The apparatus is characterized by a cap configured for releasable coupling to the container for covering the container opening, a mixing member in the container, and a user operable actuator configured for releasable coupling to the cap for selectively agitating the mixing member rotationally and/or axially.

### RELATED APPLICATIONS

The application claims the benefit of U.S. Provisional Application 62/269,813 filed 18 Dec. 2015 which is incorporated herein by reference.

### FIELD OF THE INVENTION

This invention relates generally to a mixing apparatus particularly suited for use by a consumer user for mixing nut butter and the like.

### BACKGROUND OF THE INVENTION

Oil separation occurs naturally in nut butter. Typically, between the time a jar is filled with nut butter at a production site and later opened by a consumer user, a layer of oil has formed on the nut butter upper surface. This generally requires the user to mix the nut butter before use to integrate the oil and achieve a desired palatable consistency. Typically, after removing the jar cap and protective seal, the user will use a utensil, such as a knife, to mix the separated oil back into the nut solids. With the densely packed nut solids at the bottom and a pool of oil at the top, the user's challenge is to mix the nut butter back into homogeneity without spilling the oil out of the jar or getting the oil or nut butter on one's body, clothes, the outside of the jar or other surface. This operation requires a fair amount of strength, time, and coordination, and spillage tends to occur regardless.

### SUMMARY OF THE INVENTION

The present invention is directed to mixing apparatus embodiments which can be conveniently operated by a consumer user for mixing nut butter while in its original container. After mixing, the apparatus can be easily removed from the container to provide the user ready access to the mixed container contents or to secondarily act as a utensil for spreading or otherwise distributing the mixed nut butter.

In a first preferred embodiment, the invention is directed to a product container suitable for containing a mixable material, such as nut butter. A preferred container in accordance with the invention is characterized by a jar having an access port opening to an interior volume and a mixing apparatus including a cap for covering the port, a mixing member (hereinafter, generally referred to as a “beater”) supported for movement in the interior volume, and an actuator (hereinafter generally referred to as a “knob”) configured for manual manipulation by a user to move the beater through the interior volume for mixing the material, which for convenience will hereinafter be generally referred to as nut butter.

The manually operable knob is associated with a drive member which can be selectively engaged with the beater. When a user actuates the knob in a first direction, the drive member initially engages the beater allowing further knob movement to rotate the beater through the nut butter. In addition to rotary mixing, the user can move the knob and beater vertically to axially mix the nut butter. After mixing, the knob, cap, and beater can be removed from the jar and separated for cleaning and subsequent reuse.

In accordance with an important feature of one preferred embodiment, it is contemplated that the manufacturer at a production site will fill the jar interior volume with nut butter and will mount the beater in a predetermined position in the interior volume extending into the nut butter. Consistent with standard practice, a protective tamper identifying seal can then be adhered across the jar access port. The cap and knob can then be mounted over the seal. The product container is then ready for distribution to markets for sale to consumer users.

After purchase, a consumer user can remove the cap and knob and any protective seal. He/she will then replace the cap and knob enabling him/her to rotate the knob to couple the drive member, or shaft, to the beater such that further knob rotation rotates the beater through the nut butter. Additionally, the user can separately or concurrently lift the knob to raise the beater to axially mix the nut butter.

In accordance with a useful feature of one preferred embodiment, a bracket is provided for supporting the beater in the jar so as to align the beater head for engagement by the drive shaft. The beater preferably extends through an opening in the bracket configured to wipe nut butter off of the beater blades and wings as the beater is withdrawn through the bracket opening after mixing is completed.

In an alternative preferred embodiment, the mixing apparatus can be provided as an aftermarket product and is packaged separately from the container. In use, the original container cap and seal are removed, and the mixing apparatus is thereafter mounted so as to replace the original cap. The apparatus includes a cap member, an actuator member (or “knob”), and a mixing member (or “beater”). The knob and beater are configured for ready coupling and decoupling through the cap member.

The beater can be variously configured for performing its mixing function. Preferably, however, the beater includes an end effector having a flat surface area for enabling it to be used for spreading the nut butter on a slice of bread, for example.

### BRIEF DESCRIPTION OF THE FIGURES

The embodiments of the invention are illustrated by way of example and not by way of limitation in the accompanying drawings in which like references indicate similar elements and wherein:

FIG. 1 shows an external view of a product container in accordance with the present invention;

FIG. 2 shows an exploded cutaway view of the product container of FIG. 1 primarily comprising a jar accommodating a beater, a cap, and a knob assembly;

FIG. 3 shows a cutaway view of the assembled product container of FIG. 1;

FIG. 4 is similar to FIG. 3 but shows the cap and knob assembly separated from the jar assembly;

FIG. 5 is similar to FIG. 4 but shows that the protective seal has been removed;

FIGS. 6, 7, 8 are similar to FIG. 3 after removal of the seal and respectively show the drive shaft and beater head prior to engagement (FIG. 6), the drive shaft in a position initially engaging the beater head (FIG. 7), and the beater head pulled upwardly by the drive shaft to position the beater for mixing (FIG. 8);

FIG. 9 shows the knob assembly and beater pulled upwardly in the jar after rotary mixing allowing the beater to also mix while moving vertically, i.e., axially;

FIG. 10 shows removal of the cap and beater bracket from the jar indicating a vertical action;

FIG. 11 shows the knob assembly, cap, beater bracket, and beater after removal from the jar;

FIG. 12 shows the cap and knob assembly ready for remounting on the jar after mixing;

FIG. 13 shows the cap and knob assembly remounted on the jar;

FIGS. 14 and 15 show more detailed views of the knob assembly; and

FIG. 16 shows an alternative knob construction designed to facilitate product container stacking.

FIGS. 17A, 17B show an alternative cap and seal construction which allows the cap to remain on the jar through the mixing process.

FIG. 18 shows a cutaway view of the assembled product container utilizing the alternative cap and seal shown in FIG. 17.

FIG. 19 is similar to FIG. 18 but shows the knob assembly separated from the jar assembly;

FIG. 20 is similar to FIG. 19 but shows that the protective seal and tamper wrap have been removed;

FIGS. 21-23 are similar to FIGS. 18-20 but illustrate an alternative cap construction which eliminates the need for the beater bracket;

FIGS. 24-26 illustrate a further alternative embodiment construction;

FIG. 27, 28, 29A illustrate a further alternative mixer embodiment suitable for aftermarket use and FIGS. 29B and 29C depict the operation of the mixer of FIG. 29A;

FIG. 30 is an enlarged view of the knob assembly of FIG. 29A;

FIGS. 31, 32 shows a one-way rotational ratchet mechanism between the two component parts of the knob assembly of FIGS. 31, 32;

FIGS. 33, 34 show an alternative cap that scrapes nut butter off the beater shaft back into the jar during axial mixing and allows overflow oil to drain back into the jar;

FIGS. 35, 36 depict alternative beater embodiments respectively showing a spatula style for spreading and a rod style for mixing extra dense nut butter; and

FIG. 37 illustrates the axial travel limit of the mixer for the rod style version of the beater.

### GLOSSARY

The following Glossary is submitted to facilitate an understanding of the subsequently described figures:

product 8—Consumable or non-consumable substance such as nut butter, paint, or other substances that may benefit from or require mixing;

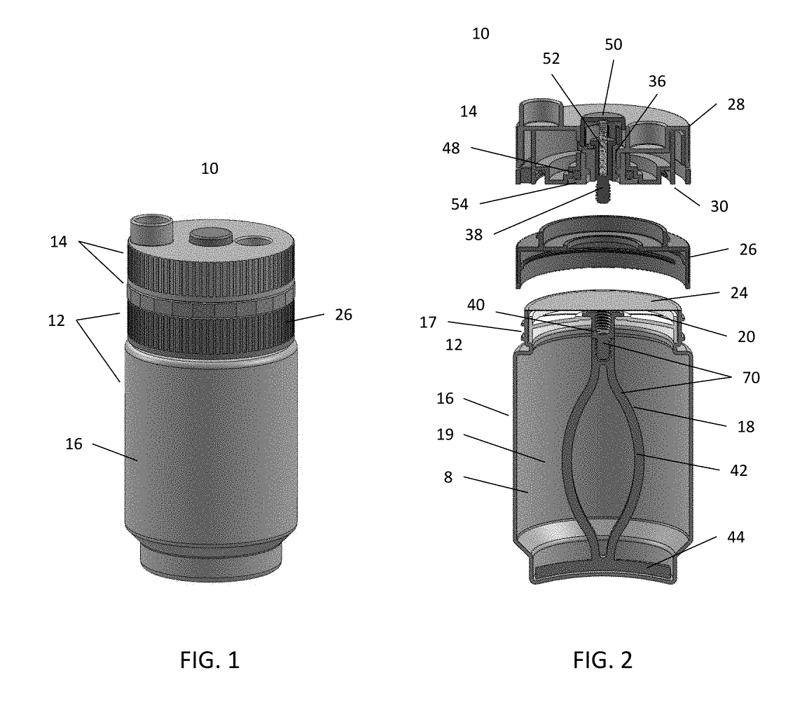

product container 10—The complete assembly shown in FIG. 1 including jar 16, cap 26, and knob assembly 14;

jar assembly 12—includes jar 16, beater 18, cap 26;

knob assembly 14—includes knob 28 and any transmission parts for connecting to and rotating beater 18;

jar 16—The container for the product 8;

beater 18—An elongated element supported in jar 16 for contacting and mixing product 8;

beater bracket 20—Holds the beater 18 in position in jar 16;

protective seal 24—Applied at production site for sealing product 8 in jar 16 for preventing contamination and identifying tampering;

cap 26—Covers the access port in jar 16 and protects the seal 24 before use; after seal 24 is removed and mixing completed, the cap 26 acts as a secondary cover of the product 8 that remains in the jar 16 after each subsequent use; acts as a base for the knob assembly 14;

knob 28—The actuator element that the user uses to rotate the beater to mix the product 8;

knob bottom 30—Base of the knob assembly 14; removably coupled to the top of cap 26; may house a gear for transmission of motion; may include tabs for restricting and limiting knob 28 direction of rotation;

knob retainer 36—Holds knob assembly 14 together; acts as a bearing for rotation;

drive shaft 38—Locks knob retainer 36 in place; receives torque and rotational motion from knob 28; transmits torque and motion into beater 18; may thread on to beater 18 or beater head 40; may displace or cut protective jar seal 24 between beater 18 and knob bottom 30;

beater head 40—Connects to the top of beater 18 via external threads 41 and to the drive shaft 38 capturing beater bracket 20 between beater 18 and beater head 40;

beater blades 42—Axial oriented adjacent mixing blades in the middle section of the beater 18;

beater wings 44—Radially oriented adjacent mixing blades at the distal section of the beater 18;

knob solid body 46—The drive shaft 38, knob washer 54, knob retainer 36, knob 28, and beater head 40 fit together and create a solid body without any leakage paths;

knob seal 48—A seal for rotational motion between the knob solid body 46 and the knob bottom 30;

drive shaft retainer 50—Located axially at the top of the knob 28. Holds the drive shaft 38 in place and drive shaft spring 52 to push the drive shaft 38 towards the beater head 40;

drive shaft spring 52—Between the drive shaft 38 and drive shaft retainer 50. pushes the drive shaft 38 towards the beater head 40;

knob washer 54—Acts as a base of the beater 18 or beater head 40 for engaging beater 18. Axially located adjacent knob 28 and drive shaft retainer 50. Makes a seal with the knob seal 48 pressing against the knob bottom 30;

beater assembly 70—The assembled beater 18 and beater head 40;

knob finger hole 72—Facilitates user rotation of the knob.

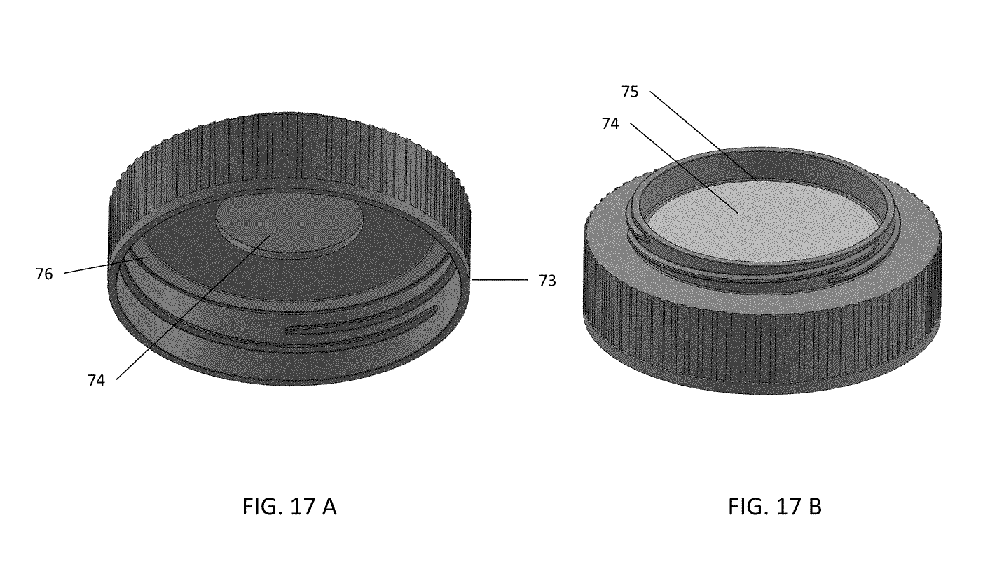

cap 73—An alternative cap (FIG. 17A) design having a cap top seal 74 and inside seal 76, both applied at production site for sealing product 8 in jar 16 for preventing contamination and/or identifying tampering.

cap wrap 78—Alternative tamper identification method.

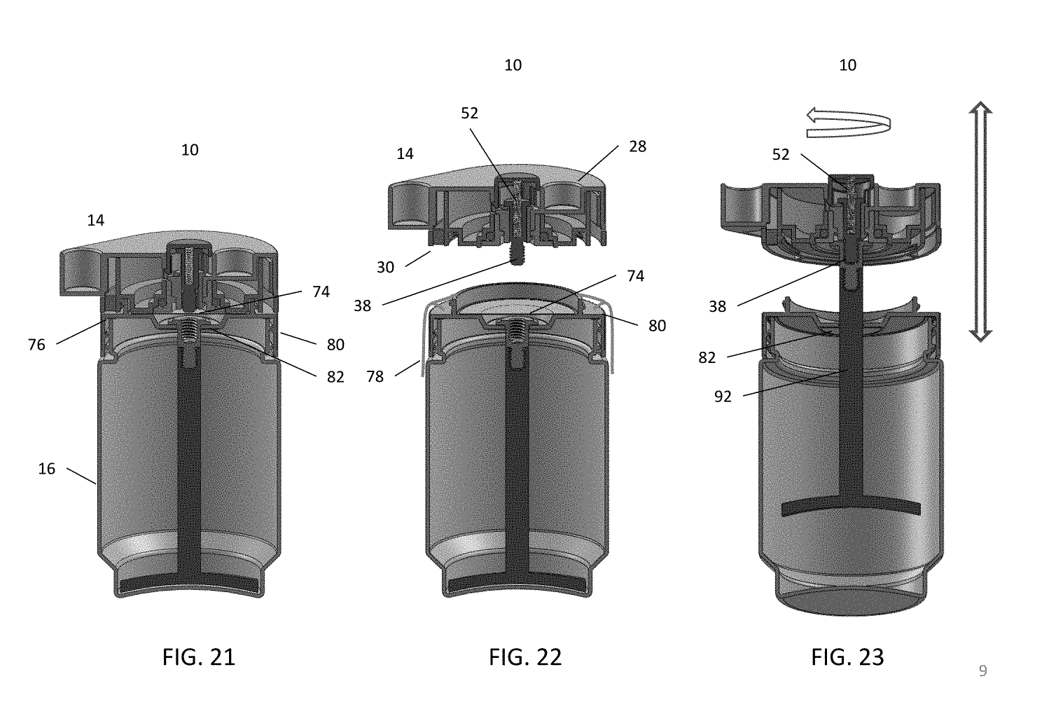

cap 80—An alternative cap (FIG. 21) having a cap wipe 82 to squeegee product off beater 92.

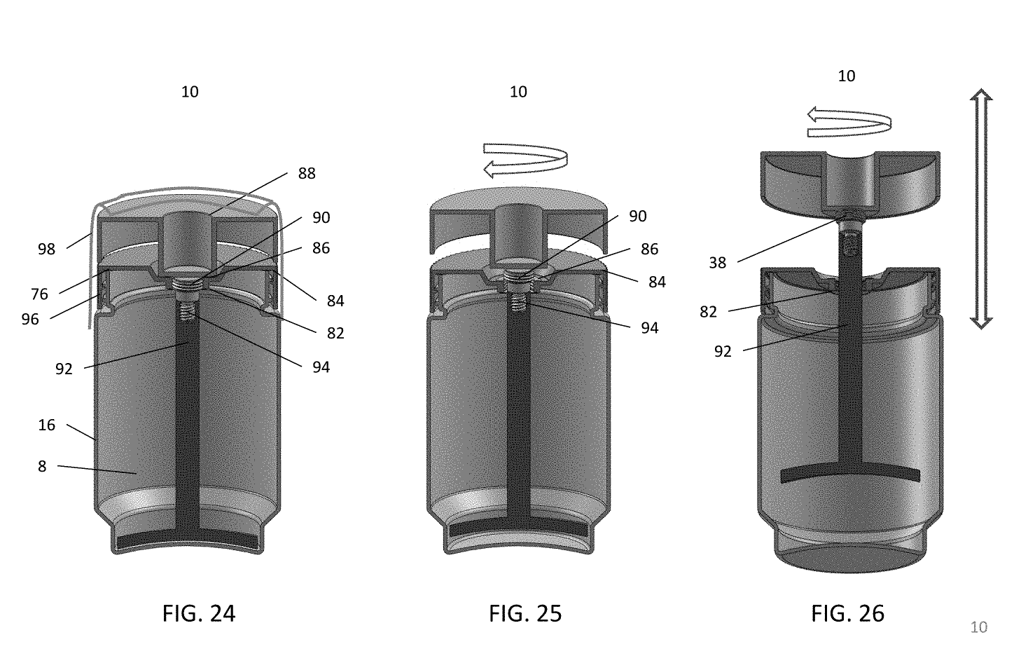

cap 84—An alternative cap (FIG. 24) associated with seal 86 and knob 88, having counter clockwise threads 90 between cap 84 and knob 88, clockwise threads 94 between knob 88 and beater 92 and clockwise threads 96 between cap 84 and jar 16.

### DETAILED DESCRIPTION

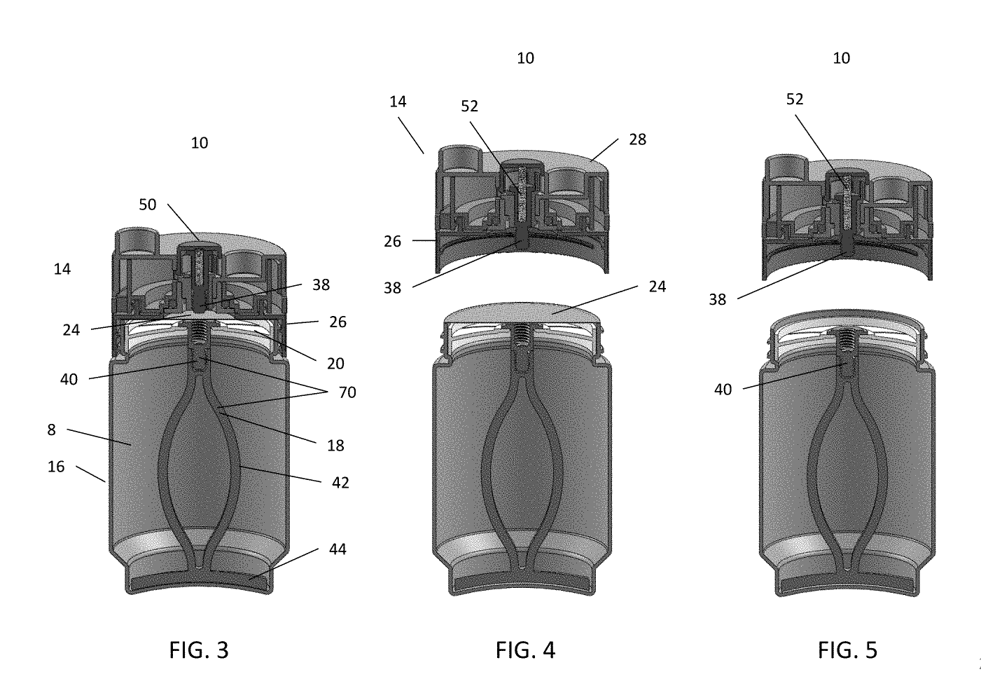

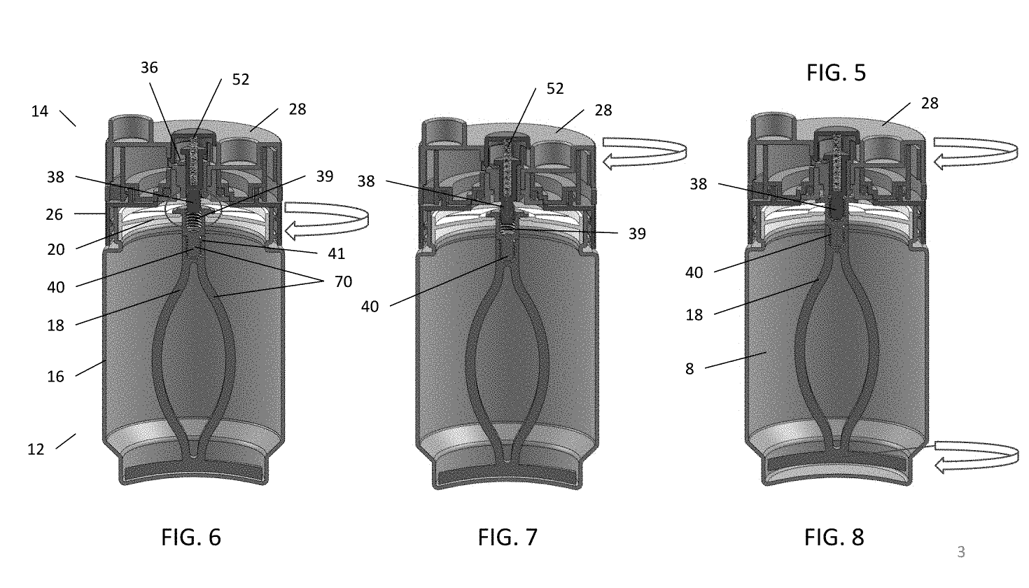

Attention is initially directed to FIG. 1 which depicts an exterior view of a product container 10 in accordance with the invention generally comprised of a jar 16, and a mixer assembly including a cap member 26 and an actuator member, or knob 28, being a component of knob assembly 14. As shown in FIG. 2, the jar 16 has an open neck 17 surrounding an access port opening to a container interior volume 19. The neck 17 is preferably externally threaded for coupling to the cap 26. A beater bracket 20 mounted within the access port supports a mixing member, or beater member 18, which extends down into the interior volume 19. At the production site, after, or prior to, filling the jar 16 with product 8, the beater assembly 70 and bracket 20 are mounted in the jar and a protective seal 24 is preferably adhered across the neck access port. With the seal 24 in place and the cap 26 and knob assembly 14 mounted on the jar neck as depicted in FIG. 3, the product container 10 is ready for shipment to markets for sale to consumer users.

Note in exploded FIG. 4 that the knob assembly 14 includes a knob member 28 carrying a drive shaft 38 which is lightly spring loaded downwardly against seal 24 accommodated in a gap between the drive shaft 38 and head 40 of beater 18. The knob assembly 14 is configured to releasably mate with the cap 26 which in turn is configured for releasable coupling to the neck of jar 16. When assembled, as depicted in FIG. 3, the cap 26 is captured between the knob assembly 14 adjacent the cap upper surface and the mixing member, i.e., beater 18 adjacent to the cap lower surface.

When the consumer user is ready to use the product 8, which will hereinafter be assumed to be nut butter, he will remove the cap 26 and knob assembly 14 from the jar neck as shown in FIG. 4. The user will remove seal 24 as represented in FIG. 4, so that when the cap 26 and knob assembly 14 are reinstalled on the jar, as represented in FIG. 6, the drive shaft 38 can drop down to allow the drive shaft external threads to engage the internal threads 39 of beater head 40 as shown in FIG. 7. Beater head external threads 41 mate with beater internal threads 43. This allows the user to rotate the knob 28 of knob assembly 14 to rotate the drive shaft 38 to pull the beater 18 upwardly as shown in FIG. 8. Continued rotation of the knob 28 rotates the beater 18 moving its blades and wings through the nut butter product 8.

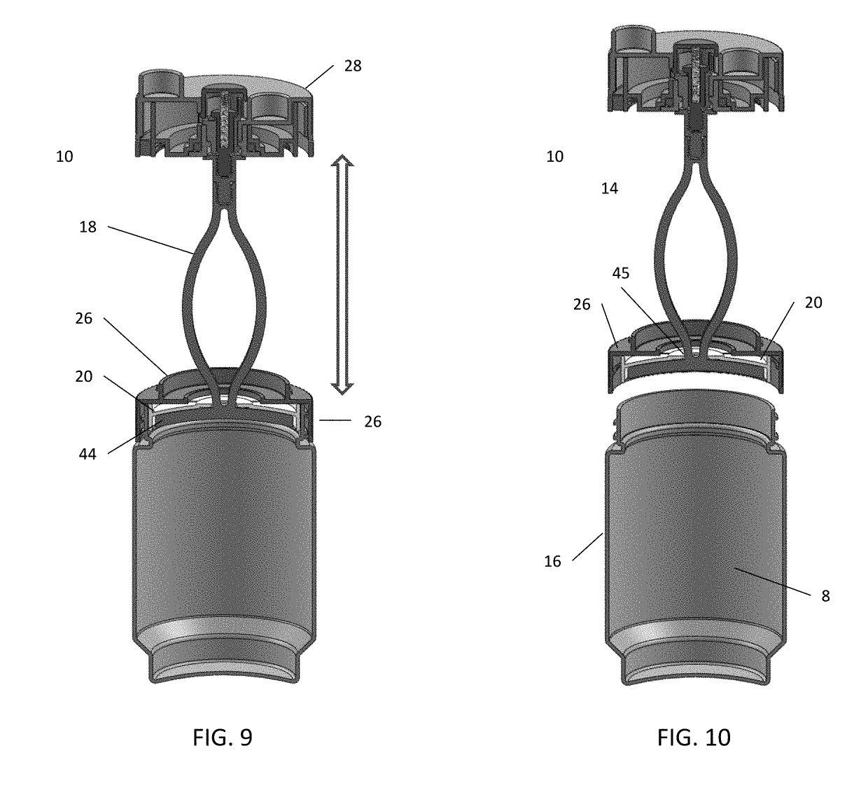

After rotational mixing is completed, the user may want to further mix the nut butter product by vertically agitating the beater. This operation is represented in FIG. 9 which shows the knob 28 detached from the cap 26 enabling the beater to move upwardly until the beater wings 44 contact the bracket 20. The user is able to repeatedly move the knob 28 up and down to enhance mixing. During vertical agitation the orientation of the knob 28 while moving up and down may also be rotated to further enhance mixing and reaching nut butter at different positions and depths within the jar. After sufficient rotational and vertical mixing, the user can then remove the beater 18 from the jar 16 as shown in FIG. 10. That is, the user will decouple the cap 26 from the jar neck to enable the beater and bracket 20 to be lifted out of the jar.

The beater 18 preferably uses a double sided blade design that deforms when extracted through the beater bracket 20 central hole. The shape of the beater 18 blades 42, when squeezed together, form the shape of the central hole 45 in the beater bracket 20. The edge of the hole acts to wipe excess product 8 from the outer surface of the beater blades 42 as they are withdrawn from the bracket. Excess product is squeezed from the blade inner surfaces as the blades conform to move through the hole. The horizontal beater wings 44 facilitate mixing, particularly the denser nut product at the bottom of the jar.

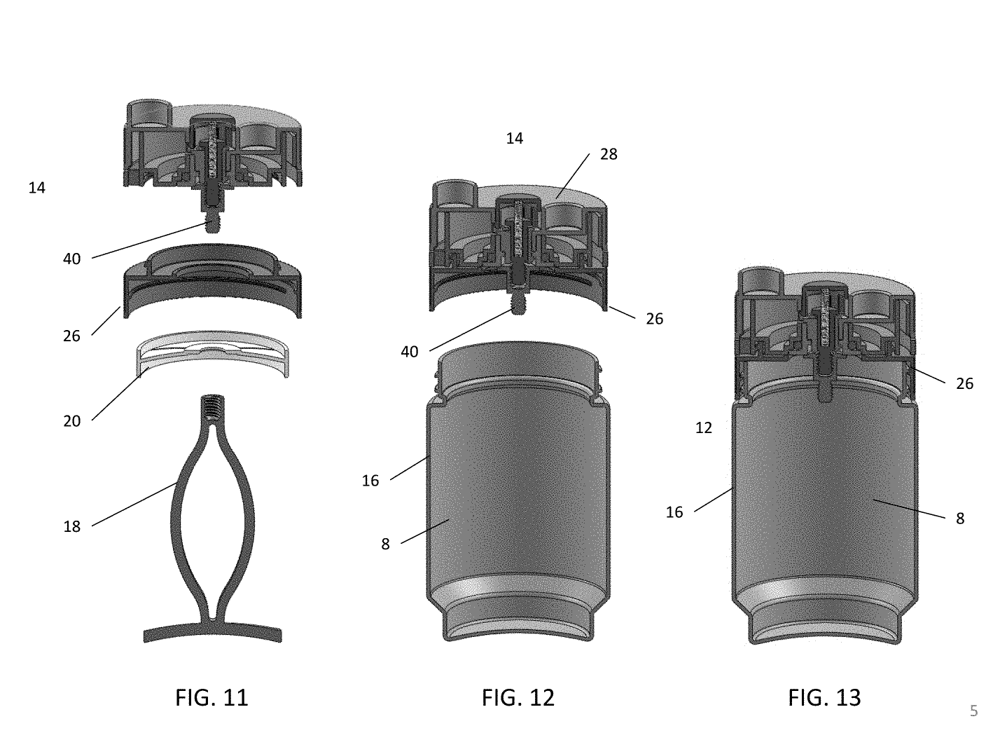

Once the product 8 has been mixed, it may be desirable to remove the beater 18 and beater bracket 20 from the jar 16 for future ease of access to the product 8. The beater 18 and beater bracket 20 may be removed from the beater head 40 by unscrewing their connection (FIG. 11) while leaving the beater head 40 in place (FIG. 12). The knob assembly 14 may remain coupled to the cap 26 without the beater 18 and beater bracket 20 (FIG. 13) to close the jar 16. Further access to the product 8 is convenient as it is now mixed and not impeded by the beater 18 and beater bracket 20.

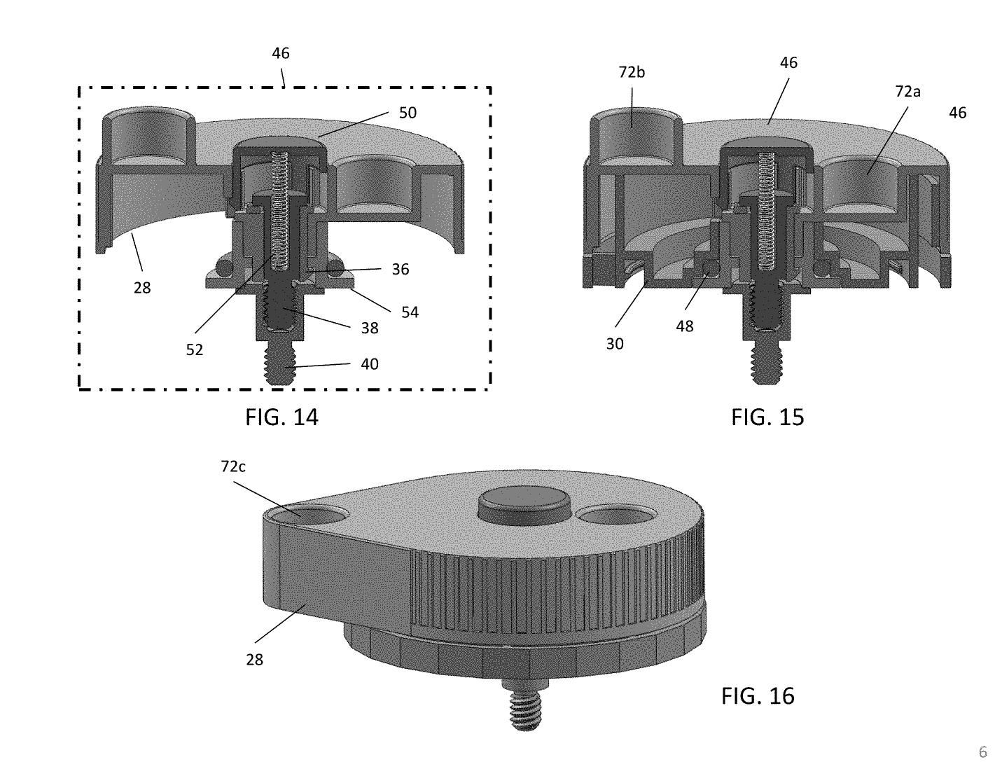

The beater head 40 when secured to the drive shaft 38 closes one of the potential paths for product 8 leakage out of the jar assembly 12. Maintaining the beater head 40 on the drive shaft 38 after removing the beater 18 helps to ensure the product 8 stays in the jar 16. As shown in FIG. 14, the drive shaft 38, knob washer 54, knob retainer 36, knob 28, and beater head 40 come together and create a solid body (knob solid body 46) such that all move in unison with no gaps for product to flow through between the beater head 40 and other components. During mixing, the knob solid body 46 rotates relative to the knob bottom 30. A knob seal 48 may be used to prevent product 8 flow between the adjacent moving parts (FIG. 15).

In use, the knob 28 can be rotated by grabbing around the circumference and rotating clockwise, as one might tighten a cap on a bottle. Initial mixing may require higher torque suitable for grabbing and rotating around the perimeter. One's hand must reposition after a limited arc of motion limiting the rate of mixing. As the Product 8 becomes more homogeneous, mixing requires less torque; a knob finger hole 72 enables continuous rotation for lighter loads. FIG. 15 shows two types of knob finger holes 72a & 72b. The first knob finger hole 72a is flush with the top of the knob 28 which is preferred for vertically stacking mixer assemblies 10. The second knob finger hole 72b protrudes from the top of the knob 28 which may extend the spacing between the hole and the axis of rotation for additional torque leverage. A third knob finger hole 72c may be located flush with the top of the knob 28 and beyond the radial edge (FIG. 16). By locating outside the radial edge of the knobs, greater leverage is provided while still permitting convenient stacking of multiple product containers. A further improvement to the knob finger hole (not shown) may include a ring or cup shaped insert within the knob finger hole providing a bearing surface such that the rotational sliding at the finger hole location occurs between the insert and the knob finger hole, thus reducing contact against the user's finger. Additional variations on the ring or cup shaped insert include a protruding handle which can be grabbed by the user's hand.

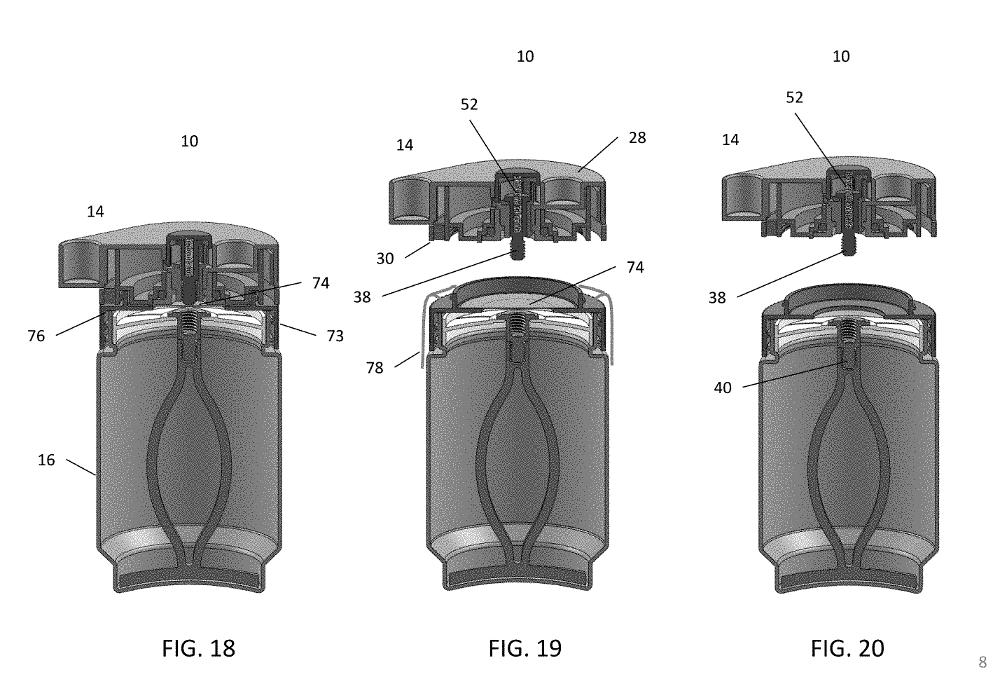

FIGS. 17A and 17B illustrate a cap construction 73 alternative to the previously discussed cap 26. The cap 73 preferably includes a top protective seal 74 stretched across and sealing cap top hole 75. The cap 73 preferably also includes an inner ring seal 76 adapted to form a compression seal against the jar neck edge to protect the product 8 from contamination with the outside environment. The cap and seal arrangement of FIGS. 17A, 17B has an advantage over the previously discussed cap 26 in that the cap need not be removed from the jar prior to mixing. That is, as shown in FIGS. 18 and 19, a user can gain access to the cap seal 74 by merely removing the knob assembly 14 from the jar. The user can then readily remove the cap seal 74 (FIG. 20) and can subsequently reinstall the knob assembly 14. A cap wrap 78 (FIG. 19) which requires removal prior to removing cap 73 and optionally knob assembly 14 can be provided for additional protection. The wrap 78 and cap seal 74 independently and together provide tamper proof identification.

FIGS. 21-23 show an alternative cap 80 having a center hole and depression for accommodating and locating the beater head 40. A cap wipe 82 around the center hole can function to squeegee off product 8 during retraction of the beater. A non-split beater 92 with a continuous cylindrical cross-section can be used as represented in FIGS. 21-23. Extraction of the beater through the center hole scrapes product 8 from the beater. The knob 28 may be rotated clockwise to stir radially, or rotated counter clockwise to release from cap 80 enabling it to be lifted to stir the product axially.

FIG. 24 shows an alternative embodiment where the knob 88 is connected to the beater 92 capturing the cap 84 during manufacturing assembly. The knob 88 includes a thread 90 that engages the cap 84 with a seal 86 to seal the product 8 in the jar 16. The cap 84 also threads to the jar 16 with a separate seal 76. A wrap 98 covers the cap 84, the knob 88, and a portion of jar 16. This wrap 98 must be removed to turn the knob 88 or the cap 84 which provides tamper identification (FIG. 24). Once the wrap 98 is removed, the user can turn the knob 88 clockwise to release from the cap 84 allowing for rotational mixing to commence immediately (FIG. 25). The threads 96 between the cap 84 and jar 16 are clockwise wound, while the threads 90 between the knob 88 and cap 84 are counter clockwise wound. This allows the knob to become unthreaded from the cap while the cap remains threaded with the jar. Similarly the knob 88 and beater 92 are connected through using a clockwise thread 94 and remains fastened through the clockwise mixing rotation of the knob 88. The beater 92 may be removed from the knob 88 post mixing to enable easier access to jar 16 and product 8. The thread 94 may be replaced with an alternative releasable connection such as a mating male and female hex shape and a snap feature. In some applications, it may be desirable to use a permanent connection with a pressed fit, bonding, or the like in lieu of a releasable connection.

Once the knob 88 is released from the cap 84, the knob may continue to be rotated for mixing. Additionally the knob 88 can be repeatedly drawn upward and plunged downward, i.e., “pumped”, to axially mix product 8 between the cap and jar bottom (FIG. 26).

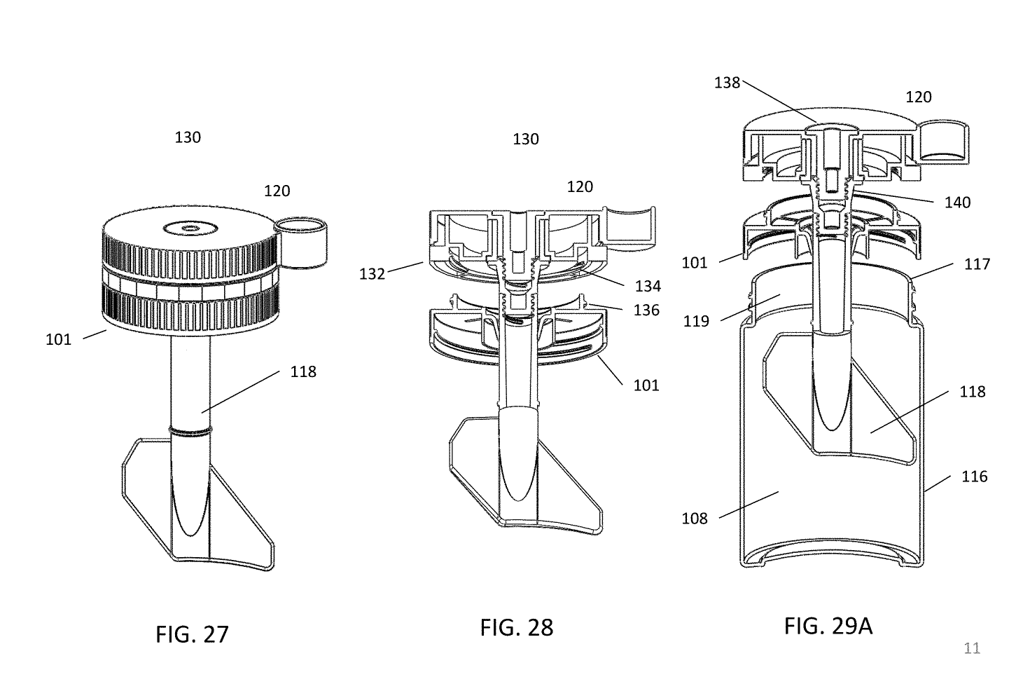

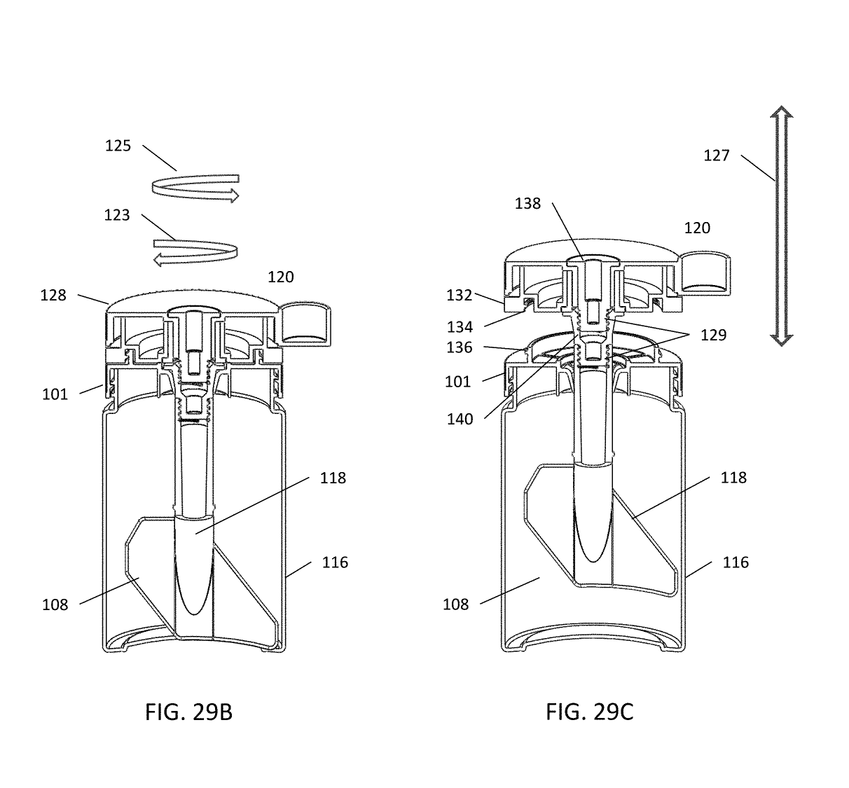

FIGS. 27, 28, 29A show an alternative mixer embodiment 130 intended for use by a consumer user for mixing the content of a jar 116 which is typically purchased separately. Attention is initially directed to FIG. 27 which depicts an assembled view of the mixer 130 which is generally comprised of a knob assembly 120, a cap 101, and a beater 118. FIG. 28 shows a cross sectional view of the mixer 130 with cap 101 separated from the knob assembly 120. As shown in FIG. 29, the mixer 130 fits into a jar 116 having an open neck 117 surrounding an access port opening to a container interior volume 119. The neck 117 is preferably externally threaded for coupling to the cap 101. The jar 116 is typically purchased by a user already filled with a product 108 such as nut butter or the like and sealed.

When the consumer user is ready to use the nut butter, he/she will first remove the cap 101 and any seal to expose the jar content. The user will then assemble (assuming initially unassembled) the knob 120, cap 101, and beater 118 and insert the beater 118 into the open jar 116, and thread the cap 101 onto the jar neck 117. The user may now mix the jar contents by selectively agitating the beater in a rotation mode or an axial mode. With the knob assembly 120 attached to the cap 101 and the cap attached to the jar 116, clockwise rotation 123 (FIG. 29B) of the knob 120 rotates the beater 118 and moves its end effector (i.e., blades, wings, rod, etc.) through the nut butter product to induce a rotational agitation.

A vertical, or axial, agitation is enabled by detaching the knob assembly 120 from the cap 101 by rotating it counterclockwise 125 enough to disengage. The knob bottom 132 has counterclockwise threads 134 that engage cap threads 136 (FIG. 29C). Rotating the knob assembly 120 and in turn the knob bottom 132 counterclockwise 125 while holding the cap 101 disengages the threads and releases the knob assembly 120 and beater 118 for vertical agitation 127 of the jar contents. Note that the clockwise threads 129 engaging the beater 118 to the beater head 140, and beater head, to the drive shaft 138, remain engaged due to their smaller pitch and greater thread length. After disengaging, the user is able to repeatedly move the knob up and down and as desired alter orientation to enhance mixing. After sufficient rotational and vertical mixing, the user will decouple the cap 101 from the jar neck to enable the mixer 130 and to be removed from the jar 116 for access to the jar content.

The mixer 130 is assembled prior to insertion into the jar 116 which allows its mechanism to be simplified. The mixer 130 contains a subset of the components required for the in-jar assemblies previously described, for example, in connection with FIGS. 1-3. It is intended that the mixer 130 can be delivered, packaged, manufactured, and distributed separate from the nut butter jar 116. This change enables a reduced functional requirement and a smaller part count. In turn, this further enables a design for ease of assembly and disassembly, for ease of cleaning, and for reuse. Separate packaging may include alternative and/or additional beaters with varying end effectors for different uses.

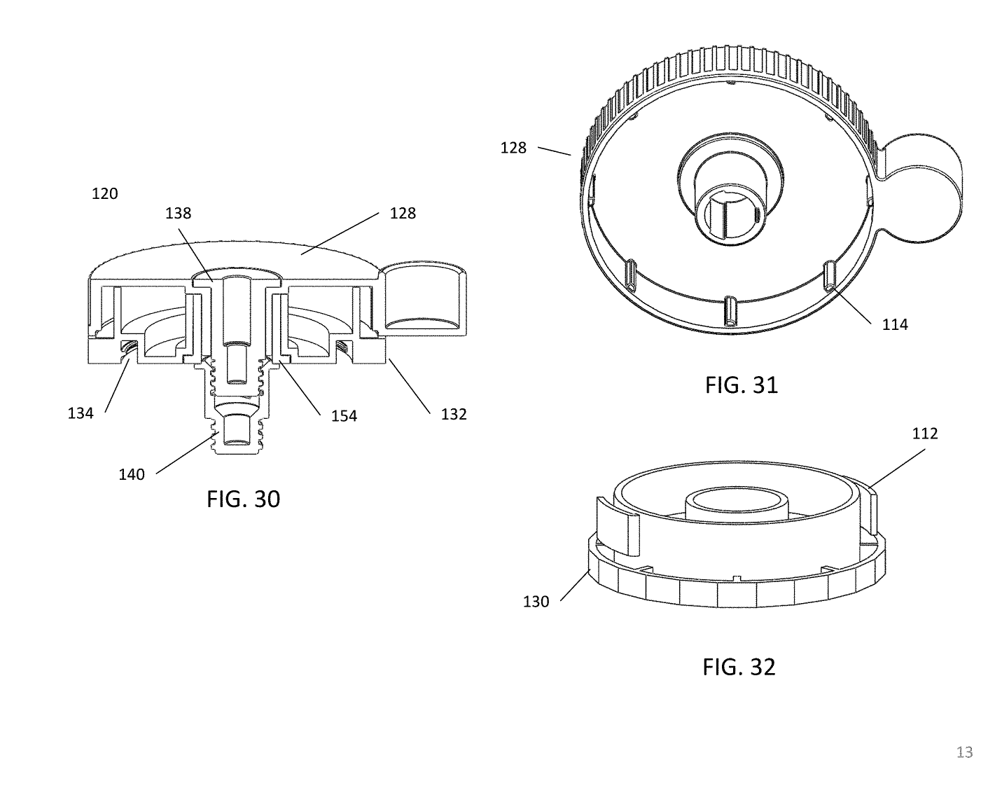

The knob assembly 120 (FIG. 30) includes the beater head 140, drive shaft 138, knob washer 154, knob 128 and knob bottom 132 and differs from the in-jar mixer of FIGS. 1-3 which requires additional components to engage the beater assembly which is initially located inside the jar.

The mixer 130 (as seen in FIGS. 27, 28) including the beater 118 and beater head 140 are preferably assembled external to the jar. The knob assembly 120 (FIG. 30) connects to the beater 118 and beater head 140 by direct coupling prior to the beater entering the jar.

FIGS. 31-32 illustrate an embodiment of a one way rotational ratchet within the knob assembly 120 and between the knob 128 and the knob bottom 132. The flanges 112 spiral radially outward and engage the tabs 114 which extend radially inward enabling the tab to bypass in one direction, while preventing rotation in the other. The clockwise rotation enables the knob 128 to rotate the beater and mix the nut butter; the counterclockwise rotating the knob unthreads the knob assembly 120 from the cap 101 (FIGS. 29B, 29C) and releases the beater 118 and knob assembly 120 to axial agitate the jar contents.

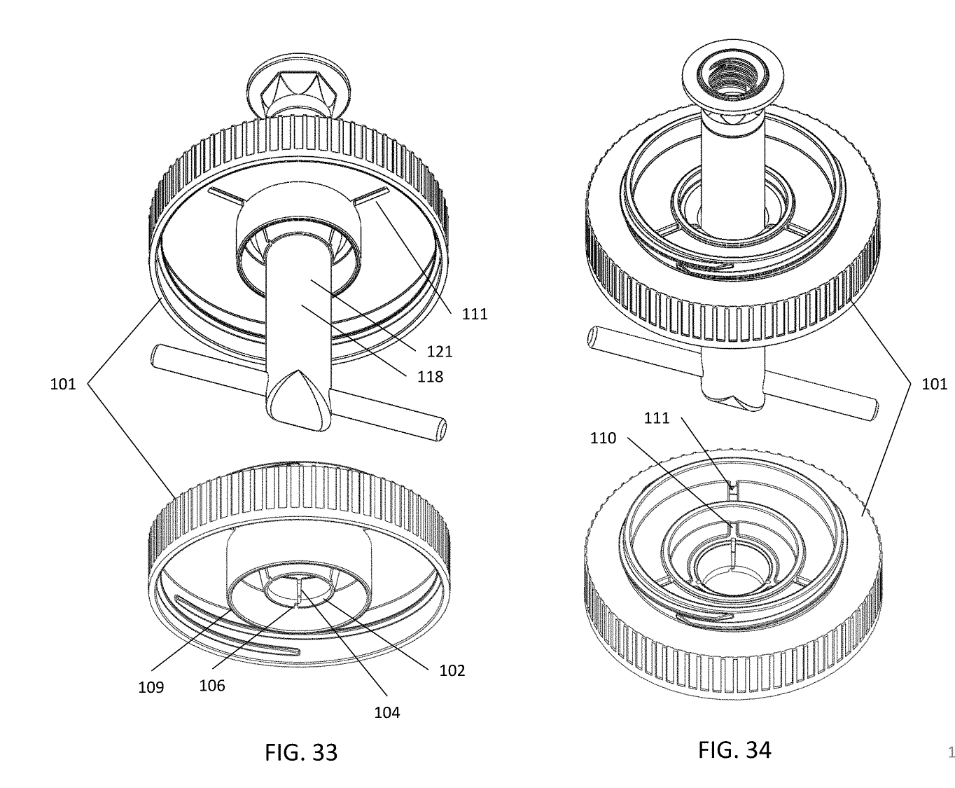

FIG. 33 shows cap 101 that uses axial tabs 102 which conform to the beater shaft 121 and function to scrape the nut butter off the beater 118 when withdrawn such that the scrapings largely flow back into the jar during axial mixing. Scraping contact is ensured by using flexible materials with either full circular contact or multiple semi-circumferential tabs with small axial gaps 104 between tabs to enable radial flexing. For the latter, a jog 106 in material may be incorporated at the distal end to scrape off the material at the location of the gap. A return column 109 contains the removed nut butter and guides it back into the jar. FIG. 34 shows the top side of the cap 101 with flow channels 110 both radially and axially to guide overflow to drain back into the jar. Additionally, vents 111 pass through the cap to allow the passage of air and to adjust for jar internal volume changes when the beater shaft is withdrawn and inserted.

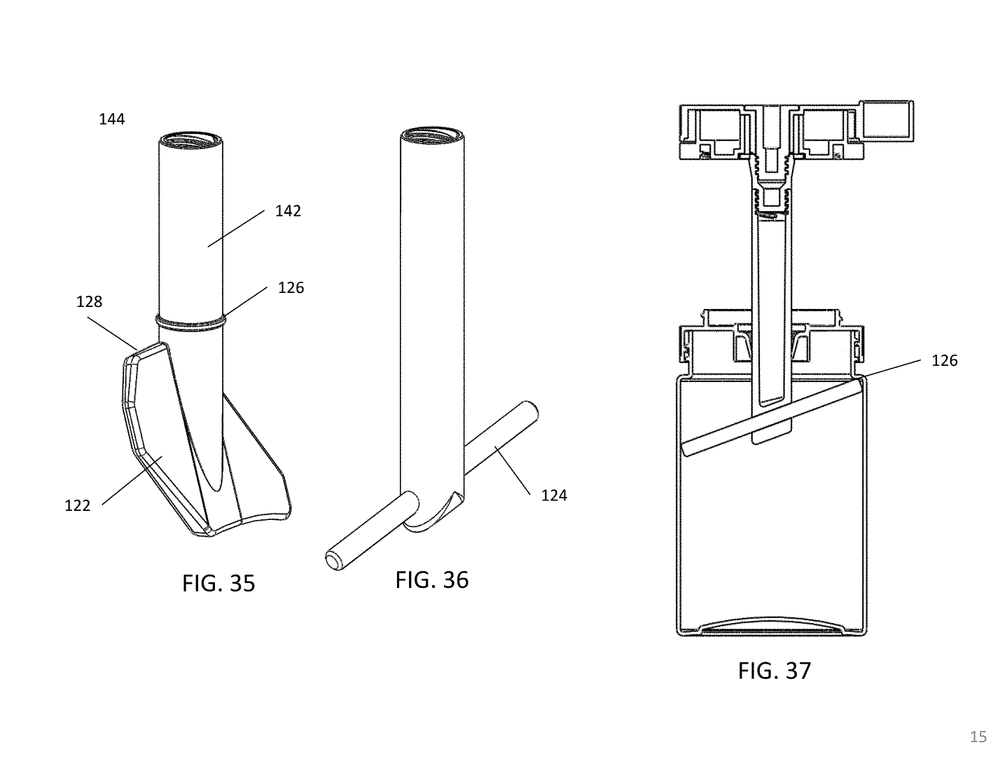

FIGS. 35-36 illustrate two alternative beaters with unique features. FIG. 35 shows a spreading beater 144 with a spatula 122 end effector that may be used to both mix and spread the nut butter. This design is particularly well suited for more fluidic or low viscosity nut butter. FIG. 36 shows a rod beater 146 with a rod style 124 end effector for slicing through dryer, thicker, and more condensed product with a relatively high viscosity. The rod 124 is preferably made out of metal or stronger material while the rest of the beater may not require the material strength and be molded out of plastic material. FIG. 35 shows a protruding ring 126 around the beater shaft 142 which acts as an axial travel limiter by contact with axial tabs 102 (FIG. 33). Alternatively the axial travel may be limited by the return column 108 (FIG. 33) in contact with the beater end effector top 128 (FIG. 35) or by the rod 124 in contact with the top inside curves 127 of the jar (FIG. 37) or other surfaces.

The spreading beater 144 is formed for the ability to both mix the nut butter and apply it onto an intended surface. During use, the user may wish to mix the nut butter prior to its use, and then conveniently use the beater 144 to apply the mixed nut butter to food or other surface. The beater 144 preferably includes a spatula style end effector having an essentially flat surface portion that can be used to both retrieve and/or apply the mixed nut butter onto a food such as bread. Alternative end effector shapes, e.g., knife or spoon, can also be used. This mitigates the need to use an additional utensil such as a separate spatula, knife or a spoon, thereby eliminating the inconvenience of obtaining an additional utensil and the effort towards the cleaning of that utensil. When the nut butter has been retrieved and/or applied sufficiently, the mixing assembly, including beater 144, can be placed back on the jar for future use.

From the foregoing, it should now be understood that an apparatus has been disclosed which can be readily operated by a consumer user for mixing nut butter and the like in the product container in which it shipped and sold to the user. Embodiments of the invention are characterized by a cap member adapted for coupling to the container, a mixing member in the container beneath the cap, and an actuator member above the cap which can be manually manipulated by the user to selectively provide rotational and axial agitation.

Multiple embodiments of the invention have been described herein which are exemplary in nature and not intended to limit the scope of the invention. It is recognized that variations and modifications will occur to those skilled in the art which are within the intended spirit and scope of the invention as defined by the appended claims.

What is claimed is:

1. A mixing apparatus suitable for mixing nut butter and the like while in a product container having an access port opening into an interior volume, said apparatus comprising:
a cap member configured for removable mounting on said container so as to cover said access port;
a mixing member having an end effector extending into said container interior volume; and
an actuator coupled to said mixing member and selectively operable in a rotation mode for rotating said end effector in said interior volume and in an axial mode for axial agitation in said interior volume.

2. The apparatus of claim 1 wherein said actuator includes guide means engaging said cap member in said rotation mode for restricting said actuator to rotational motion.

3. The apparatus of claim 2 wherein said actuator in said axial mode is disengaged from said cap member and able to move axially.

4. A product container for nut butter and the like incorporating a user operable mixing assembly, said product container comprising:
a jar having an access port opening to an interior volume;
a mixing member supported for movement in said interior volume;
a seal removably mounted adjacent to said access port for sealing said interior volume to avoid contamination of a product therein; and
an actuator mounted on said jar adapted to be manipulated by a user to move said mixing member in said interior volume.

5. The product container of claim 4 wherein said mixing member is supported for rotational movement in said interior volume.

6. The product container of claim 5 wherein said mixing member is supported for axial movement in said interior volume.

7. A mixing apparatus for use with a container having an access port opening to an interior volume and suitable for containing nut butter and the like, said apparatus comprising:
a cap member having upper and lower surfaces and configured for removable coupling to said container to cover said access port;
a mixing member having an upper head portion and a lower end effector portion, said mixing member adapted for positioning in said container with said upper head portion located proximate to said cap member;
an actuator member removably mounted proximate to said cap member and configured for selective rotation relative thereto; and wherein
said actuator member is configured for coupling to said mixing member for transferring said rotation thereto.

8. The apparatus of claim 7 wherein said actuator member is mounted for selective axial motion relative to said cap member and is coupled to said mixing member for transferring said axial motion thereto.
